(19) United States
(12) Patent Application Publication
(10) Pub. No.: US 2020/0217428 A1
(43) Pub. Date: Jul. 9, 2020

(54) ADAPTER DEVICE AND METHOD FOR REGULATING A CONTROL CURRENT

(71) Applicant: HYDAC ACCESSORIES GMBH, Sulzbach/Saar (DE)

(72) Inventors: Joerg STEFFENSKY, Dillingen (DE); Mathias Leo JIRGAL, Saarbruecken (DE); Martin SCHMITT, Knopp-Labach (DE); Stefan Christian SAUER, Schwalbach/Elm (DE); Christoph MEYER, Saarbruecken (DE)

(21) Appl. No.: 16/648,318

(22) PCT Filed: Sep. 17, 2018
(86) PCT No.: PCT/EP2018/075095

§ 371 Date: Mar. 18, 2020

(30) Foreign Application Priority Data
Sep. 23, 2017 (DE) 10 2017 008 944.2

(51) Int. Cl. F16K 27/00; F16K 27/02; F16K 31/06

(52) U.S. Cl. CPC F16K 27/003; F16K 31/0651; F16K 27/029

(57) ABSTRACT

1. An adapter device for regulating a control current and method of operating a corresponding adapter device
2. An adapter device is provided for regulating a control current (iₛ) of a magnetic force actuator (32) of a valve (6), having a housing (8), into which the hardware (H) and the software (S) for regulating the control current (iₛ) of the magnetic force actuator (32) of the valve (6) are integrated, and which has a connection device (14) for detachably connecting to the valve (6) and a further connection device (18) for detachably connecting to a connector part (4), which can be used to supply the adapter device with current at least externally.

The invention relates to an adapter device and a method for regulating a control current of a device actuating the magnetic force of a valve, in particular in the form of a coaxial valve.

From DE 10 2011 010 938 A1, a magnetically directly controlled valve of coaxial design is known, which is controlled by means of an electronic system, which detects and evaluates the applied voltage and current flow at any time of valve actuation, which flows through a solenoid coil arranged in the valve, which serves as a magnetic force actuator for a magnet keeper, which is used to open and close the actuated valve by means of a valve piston axially movable in opposite directions in a valve housing.

The electronics can change the current and voltage values applied to the known solenoid coil, which are used for actuating the coil, in analog or digital form. In this way, the applied voltage or the current flowing through the solenoid coil can be altered in an analog manner or regulated in a digital manner, for instance by means of pulse width modulation. In the known solution, the magnetic force actuator in the form of the solenoid coil is, for the purpose of energizing it, connected to a connector part, which is directly connected externally to the valve housing, permanently wired to the solenoid coil and therefore connected in a non-interchangeable manner to the coil actuation of the electronics, which has a corresponding signal input on its input side in addition to the power supply.

In this way, the pressure-compensated, well-known coaxial valve can be operated at very low electrical power and can be regulated continuously regarding the valve position; only the connector part in conjunction with the upstream electronics is always adapted to a certain valve type in terms of its design and technical layout and therefore cannot be used modularly for different types of valves and valve types. Different manufacturers also use different types of standardized connector parts to actuate the individual, different valve types, also in the form of coaxial valves, having different flow characteristics, i.e., in order to satisfy the demands of every type of plug and valve, independent electronics must be designed and connected upstream of the connector part.

Based on this state of the art, the invention addresses the problem of improving the known solution.

An adapter device having the features of claim 1 in its entirety solves this problem. The adapter device according to the invention is used to regulate a control current of a magnetic force actuator of a valve, in particular in the form of a coaxial valve, having a housing, into which the hardware and the software for regulating the control current of the magnetic force actuator of the valve are integrated and which has a connection device for detachably connecting to the valve and a further connection device for detachably connecting to a connector part, which can be used to supply the adapter device with current at least externally; however, measuring devices, data loggers and evaluation devices can also easily be connected.

In the solution according to the invention, a kind of intermediate plug is realized via the adapter device based on integrated hardware and software, which intermediate plug can be installed between the relevant valve or coaxial valve and its solenoid coil and the actual standard connector part, which is specified by the manufacturer in a space-saving, modularly exchangeable manner.

In this way, it is also possible to easily retrofit existing fittings in the form of valves used in fluid systems, such as coaxial valves. Because the software can be individually implemented in the hardware of the adapter device, complex control and evaluation processes for actuating the connected valve of a given valve type can be obtained directly on site. However, it is also possible to “activate” only individual functions of the software in a particularly cost-effective manner, for instance to dampen closing impacts, which can occur regularly and at a higher intensity during the operation of coaxial valves in connected fluidic systems, or a so-called “condition monitoring” of the valve can be performed by means of the implemented software, without the need for any additional measurement and evaluation equipment being set up externally in a control cabinet or on the valve itself, which regularly requires the use of a more complex overall control system and software. The “island solution” with its integrated software implementation on site, i.e. directly on the valve, has shown that the control and regulation effort can be reduced in a targeted manner.

Without having to make any changes to the fluid system to which the valve is connected, the user can retrofit an existing system using the adapter device in accordance with the invention in an advantageous way without any great expenditure in terms of equipment. In particular, the user of such systems will welcome the fact that he can continue to use the standardized connector parts he purchased and used by simply plugging them into the connection device of the adapter device and in this respect adhere to the wiring concept he introduced. This is without parallel in the prior art.

Furthermore, according to the configuration of features of patent claim 18, the above problem is also solved by a method for regulating a control current of a magnetic force actuator of a valve, such as a coaxial valve, which has at least one coil that is equipped with the adapter device according to the invention described above.

In a preferred exemplary embodiment, the connection device has means for connecting the detachable mechanical and electrical connection of the adapter device to the valve, in particular for connecting it to the magnetic coil of the magnetic force actuator of the valve, and the further connection device has means for mechanically and electrically connecting the adapter device to the connector part in a detachable manner. For this purpose, plug and socket parts, which can be brought into engagement with each other in the usual, in particular standardized, form, having female and male contact parts, are used for the detachable mechanical and electrical connection.

The hardware may comprise a computing unit, in particular a microcontroller, on which a method for regulating the control current is implemented in the form of software. The use of a microcontroller as a computing unit has the advantage that microcontrollers are inexpensive, use little energy and can be installed in a space-saving manner.

All components of the hardware can be arranged on a printed circuit board and are electrically connected to each other using conductive tracks, as described below. The circuit board can be designed to be mounted to the housing of the adapter device.

Furthermore, the hardware may include at least one rotary switch to parameterize the adapter device, in particular the software implemented on the computing unit. The rotary switch is electrically connected to the computing unit, in particular to a sequencer software-implemented on the computing unit. The rotary switch is preferably designed as a coding switch. Coding switches are characterized by being very reliable and easy to operate.

Preferably three rotary switches are provided. A first rotary switch is provided for setting an operating mode of the adapter device, such as an operating mode reducing the power of the magnetic force actuator or an operating mode having the function of damping the closing impact of the valve or an operating mode in the form of a service mode. If the adapter device is used for the first time in combination with an individual valve, the former has to be adapted to this valve by means of a parameterization of the software parameters adapted to the individual valve. For this purpose, among other things, a second rotary switch is provided for setting the nominal size (DN10 to DN40) of the individual valve, which refers to the free connection cross-sections of the valve. A third rotary switch is provided for adjusting the switch-on and switch-off speed of the valve. It is particularly preferred that at least the second and the third rotary switch have sixteen switching positions, permitting the selection of sixteen options for setting different nominal sizes of the valve via the second rotary switch and sixteen combinations of different switch-on and switch-off durations can be selected via the third rotary switch.

The hardware may further comprise at least one display means for indicating a faulty operating state of the valve or for indicating the switching position of a valve part of the valve. The display means can be controlled by the computing unit and connected to the sequencer, which is software-implemented on the computing unit. The display means can be arranged in such a way that it is visually or acoustically perceptible from outside the adapter device for an operator of the adapter device. It is also conceivable that the sequencer transmits an electrical signal via a data line to an external main computer unit, i.e. one that is located remotely from the valve, the adapter device and the connector part, from which the faulty operating state of the valve, the switching position of the valve part of the valve or further information of the adapter device or the valve can be obtained. It is also conceivable that such a signal is transmitted wirelessly between the sequencer and the main computer unit, in particular using Bluetooth technology.

The hardware may also have an output stage, which is connected on the input side to the computing unit, more specifically to an output of a current regulator software-implemented on the computing unit.

The output stage is supplied with a pulse-width modulated (PWM) signal from the current regulator to regulate the control current. The software computes the duty cycle of the PWM signal, which indicates the percentage of the maximum power that the pulse-width modulated signal feeds to the output stage. By means of a pulse-width modulated signal, the output stage can be operated in the switching mode, in which its transistors are either in a conducting or isolating mode. In contrast to the intermediate states used in conventional class A, class B or class AB amplifiers, these two modes have relatively little power dissipation in linear operation, which means that the output stage, which is preferably in the form of a class D amplifier, is low-energy.

The output stage essentially has a half-bridge of, preferably two, transistors in combination with a suitable driver module. An output stage designed as a half-bridge has a higher overall efficiency than an output stage designed as a full bridge, having for instance four transistors, due to lower switching losses. On the output side, the output stage can be connected to a coil of the magnetic force actuator via the connection device. The energy consumption of the valve can be reduced by emitting a pulse-width modulated signal, namely the control current or the control voltage, of the output stage for actuating the coil of the magnetic actuating device.

The hardware can additionally comprise a current detection device for determining an actual value of the control current of the coil, which is connected to the computing unit on the output side, in particular to a resistance value computing module and/or to an induction voltage computing module and/or to the current regulator and/or to the sequencer, which are each software-implemented on the computing unit.

The current detection device can have a shunt resistor, which can be connected to the coil of the magnetic force actuator via the connection device in such a way that the current through the coil also flows through the shunt resistor, across which the voltage drop is measured to determine the actual value of the control current. The control current is the supply current of the magnetic force actuator flowing into the magnetic force actuator. The resistance value of the shunt resistor is preferably in the milliohm range or smaller. The advantage of measuring current using a shunt resistor is that it is inexpensive and space saving, and it renders current measurement easy. However, the use of a Hall-effect current sensor for measuring the control current is also conceivable.

The hardware can also include a voltage detection device for determining the actual value of the control voltage of the magnetic force actuator, by means of which the actual value of the control voltage of the coil of the magnetic force actuator can be tapped on the input side using the connection device and which, on the output side, is connected to the computing unit, specifically to the resistance value computing module and/or to the induction voltage computing module and/or to the sequencer, which are each software-implemented on the computing unit. The control voltage is the supply voltage of the magnetic force actuator applied to the magnetic force actuator.

For amplifying the actual value of the control current, the current detection device may have an amplifier, the gain of which is adapted to an input-side analog/digital converter of the computing unit for processing the actual value of the control current. Alternatively or additionally, the voltage detection device for amplifying the actual value of the control voltage can have a further amplifier, the gain of which is adapted to another input-side analog/digital converter of the computing unit for processing the actual value of the control voltage.

The software implemented on the computing unit may comprise a software-implemented resistance value computing module for determining the value of the resistance of the coil of the magnetic force actuator, one input of which is connected to an output of the voltage measuring means and another input of which is connected to an output of the current determining means and, on the output side, is connected to an input of a software-implemented induction voltage computing module. The resistance value computation module computes the resistance of the coil, which alters depending on the temperature. For purposes of computation, the valve section is assumed to be stationary.

One input of the software-implemented induction voltage computation module for determining the actual value of the induced voltage of the coil of the magnetic force actuator is connected to an output of the resistance value computation module, another input is connected to the output of the voltage determination device and another input is connected to the output of the current determination device. On the output side, the induction voltage computation module is connected to a voltage regulator software-implemented on the computation unit.

The software may also include a software-implemented sequencer for processing predetermined control signals for actuating the valve and/or a predetermined parameterization of the adapter device, which can be connected to the external main computing unit via the further connection device and via the connector part for communication, for instance by means of the SDCI standard (single-drop digital communication interface for small sensors and actuators, standard IEC TR 61131-9), better known as the IO-Link communication system. The main processing unit transmits control signals to the sequencer system to regulate the valve, among other things.

On the input side, the at least one hardware rotary switch and/or the output of the current detection device and/or the output of the voltage detection device are connected to the sequencer unit and on the output side, the latter is connected to a voltage regulator for transmitting set values of the induced voltage to a voltage regulator or to a current regulator for transmitting set values of the control current, which are each software-implemented on the computing unit.

The software can also include the software-implemented voltage regulator, which is connected on the input side to the sequencer for transmitting set values of the induced voltage and to the voltage computation module for transmitting actual values of the induced voltage, and which is connected on the output side to an input of the current regulator if necessary. The voltage regulator regulates the induced voltage of the coil based on the set value and the determined actual value of the induced voltage by emitting a signal, which is used to derive the set value of the control current.

The control voltage is the supply voltage of the magnetic force actuator applied to the magnetic force actuator. However, the induced voltage of the coil, which drops directly across the coil, deviates from the control voltage for a certain time when the control voltage or the control current change. Thus a change in the control voltage or current results in a change in the magnetic flux through the coil. According to Lenz's law, the change in magnetic flux induces a voltage in the coil, which influences the value of the control voltage. As a result, when the control voltage changes positively, i.e. a voltage increase, the control current only gradually increases to its final value. In the case of a negative change in the control voltage, i.e. a voltage decrease, the current can still flow if a corresponding circuit remains established.

A voltage can be induced in the coil when the air gap closes because the magnetic circuit around the coil, through which the current flows aims at reducing its magnetic resistance by, for instance, closing an air gap. The control voltage is only indirectly influenced by the current regulator.

The software can also include the software-implemented current regulator, one input of which is connected to the sequencer or to the output of the voltage regulator for transmitting set values of the control current and the other input of which is connected to the current detection device. The current regulator regulates the control current to the specified setpoint value.

The software may also include a software-implemented switch that can be controlled by the sequencer and that connects one input of the current regulator to either the sequencer or the output of the voltage regulator.

The software may include other software-implemented functions in addition to the function of regulating the control current of the coil of the magnetic force actuator. Conceivable, for instance, is a function for reducing the current of the coil, in particular in continuous operation; and/or a function for moving the valve part at a predeterminable speed when switching on and off; and/or a function for detecting the switching state of the valve; and/or a function for monitoring valve parameters, such as the switching cycles, the lengths of the on/off intervals, the pick-up/drop-out current and/or the coil resistance.

According to claim 18, the subject matter of the invention is also a method for regulating a control current of a magnetic force actuator of a valve, which has at least one coil, which can be used to operate the adapter device according to any one of the claims 1 to 17.

The method comprises the following process steps:
a current detecting device determines an actual value of the control current of the coil;
a current regulator compares the determined actual value of the control current to a set-point value of the control current; and
the current regulator regulates the control current of the coil, based on the result of the comparison.

The setpoint value of the control current can be predetermined by parameterization or determined according to the further process steps listed below:
a voltage determination device determines an actual value of the control voltage of the coil;
a resistance value computation module determines a resistance value of the coil from the actual value of the control voltage and the actual value of the control current;
an induction voltage computation module determines an actual value of the induced voltage of the coil from the resistance value, from the actual value of the control voltage and from the actual value of the control current;
a voltage regulator compares the determined actual value of the induced voltage to a set-point value of the induced voltage, which can be predetermined by parameterization; and
the voltage regulator determines the setpoint value of the control current, based on the result of the comparison.

When using the setpoint value of the control current determined according to the preceding process steps for the regulation of the control current, the control current can be regulated particularly accurately, in particular due to the inclusion of the induced voltage of the coil.

Below, the adapter device according to the invention, which can be operated by the method according to the invention in the form of software, will be explained in more detail with reference to the drawing. In the figures, in general view, not to scale,

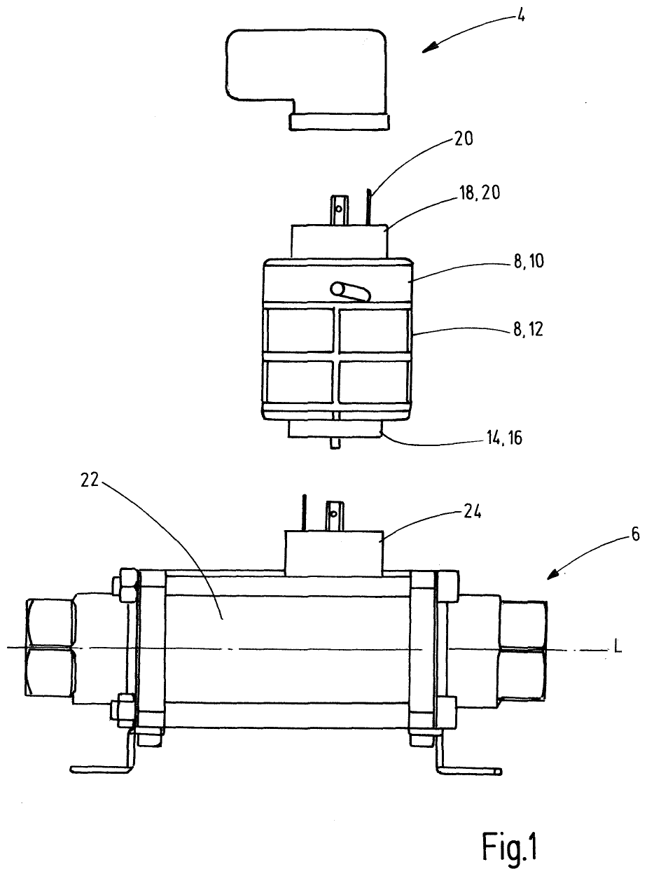

FIG. 1 shows the adapter device between a connector part and a valve according to the invention in side view, separately from each other;

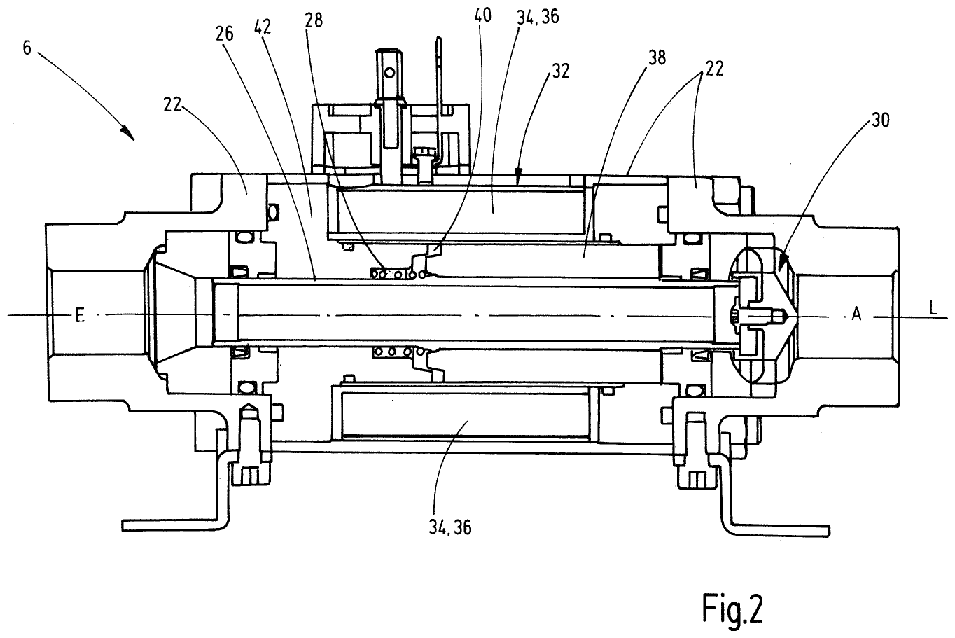

FIG. 2 shows a schematically simplified longitudinal section of the valve of FIG. 1 having a valve part arranged in its closed position; and

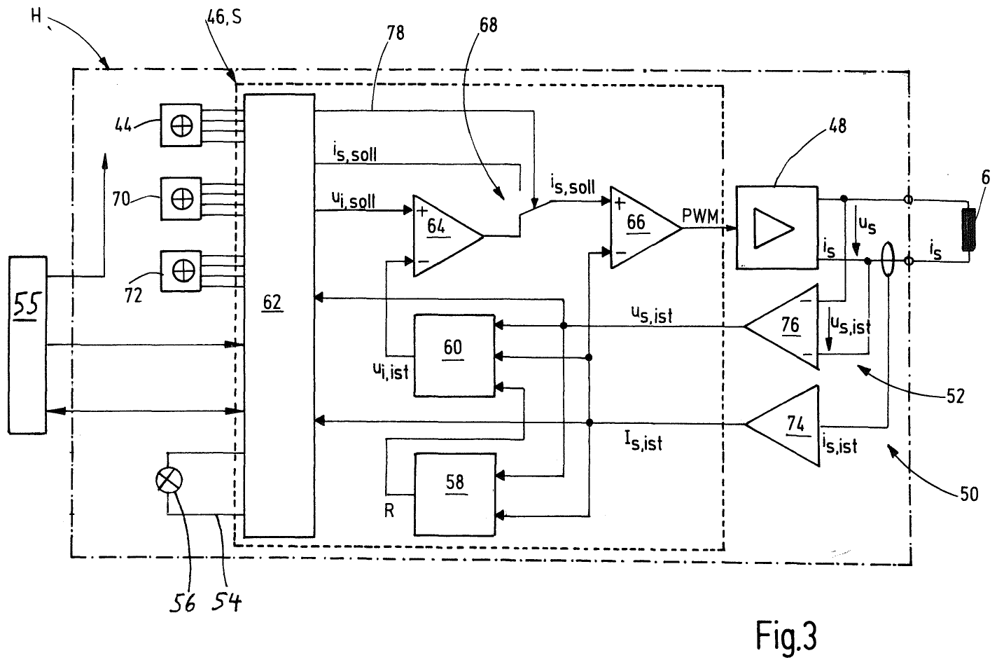

FIG. 3 schematically shows in a kind of circuit diagram the basic structure of the hardware and software of the adapter device according to FIG. 1.

FIG. 1 shows a side view of the cylindrical adapter device according to the invention between a standard connector part 4 and a valve 6, which are shown separately from each other. Industrial connection standards, such as M12 or PG cable glands, etc., are used as standardized or standard connector parts 4.

As shown in FIG. 1, the adapter device has a cylindrical housing 8, which comprises a housing cover 10 and a housing body 12, which can be interconnected by a bayonet fitting, permitting a mechanical interconnection of the two housing parts 10, 12 that can be quickly established and opened again. For sealing purposes, a sealing ring not shown in the figures can be arranged between the housing cover 10 and the housing body 12. A connection device 14 for mechanically and electrically connecting the adapter device to the valve 6 is provided on the housing body 12, extending in the axial direction away from the adapter device, which has means 16 for the detachable mechanical and electrical connection of the adapter device to the valve 6 in the form of a female connector. On the housing cover 10, extending axially away from the adapter device in a direction opposite to the direction of extension of the connection device 14, a further connection device 18 is provided for connection to a connector part, which has means 20 for the detachable mechanical and electrical connection of the adapter device to the standard connector part 4 in the form of a male connector.

The standard connector part 4 shown in FIG. 1 is a valve connector in the form of a female connector angled by 90 degrees, which can be electrically and mechanically detachably connected to the male connector 20 arranged on the housing cover 10 of the adapter device.

As shown in FIG. 1, the valve 6 has a cylindrical valve housing 22, on the outside of which, extending radially away from the longitudinal axis L of the valve housing 22, a connection device 24 is arranged in the form of a male connector, which is substantially square in shape and has a concave surface having a radius, which permits this surface of the connection device 24 to bear positively against the valve housing shell, on its side facing the valve housing 22. The male connector 24 of the valve housing 22 can be electrically and mechanically detachably connected to the female connector of the adapter device.

FIG. 2 shows a schematically simplified longitudinal section of the valve 6 in the form of a coaxial valve. A hollow, cylindrical valve part 26 is guided for longitudinal movement in the valve housing 22, which valve part is in contact with a valve closing part 30 in a closed position under the action of an energy accumulator 28 in the form of a compression spring, in which it blocks the fluid path through the valve 6 between a fluid inlet E and a fluid outlet A along a predeterminable flow path for a fluid, such as a hydraulic fluid (oil).

In at least one open position not shown in more detail in the figures, in which the valve part 26, controlled by a magnetic force actuator 32, disengages from the valve closing part 30 in its axial direction of travel against the action of the compression spring 28 and lifts off from the latter, the fluid path through the valve 6 between the fluid inlet E and the fluid outlet A along the predeterminable flow path is opened for the fluid.

The magnetic force actuator 32 shown in FIG. 2 comprises an energizable actuating magnet 34, which has a coil winding 36 in the usual manner and is therefore no longer described in detail, which can be energized externally via the connector part 4, the adapter device and the connection device 24 of the valve. Furthermore, a longitudinally movable magnet keeper 38 is provided, which acts directly on the valve part 26 under direct contact and is firmly connected thereto. When the coil 36 is energized, the magnet keeper 38 travels—viewed towards FIG. 2—to the left from its de-energized state of the coil 36 shown in FIG. 2 and moves the valve part 26 to the left in the same way, against the action of the energy accumulator 28 in the form of the compression spring. In the fully open position of the valve part 26, the armature 38 of the actuating magnet 34 has been moved until it is in full contact against a pole core 42 of the actuating device 32, leaving a separating gap 40 or air gap open, which is used as a graduated magnetic separation for the actuating magnet 34.

A hardware H for regulating the control current iₛ of the magnetic force actuator 32 of the valve 6 is integrated into the adapter housing 8, which device has a printed circuit board—not shown in the figures—on which essentially—see FIG. 3 (the switching symbols shown in FIG. 3 are not conventional technical circuit symbols)—three rotary switches 44, 70, 72 in the form of coding switches, a computing unit 46 in the form of a microcontroller, an output stage 48, a current detection device 50 and a voltage detection device 52 are arranged. In addition, a power cable 54 is used to connect a display means 56 in the form of a lamp to the circuit board. The display means can also be located on the circuit board, in which case the cover 10 is transparent. These hardware components interact with each other as described below, electrically connected via conductive tracks on the printed circuit board, and can be electrically connected to an external main computer unit 55 shown in FIG. 3 in part via the connection device 14 of the adapter device to the magnetic force actuator 32 of the valve 6 or via the further connection device 18 of the adapter device and the connector part 4. A software S for regulating the control current iₛ of the magnetic force actuator 32 of the valve 6 is implemented on the computing unit 46 of the adapter device, which software essentially comprises a resistance computing module 58, an induction voltage computing module 60, a sequencer 62, a voltage regulator 64, a current regulator 66 and a switch 68, which are each software-implemented on the computing unit 46 and which interact as shown below.

The sequencer 62 is connected to the external main computing unit not shown in the figures in a communicating manner via the further connection device 18 and via the connector part 4. The IO-Link communication system is provided for communication. The sequencer 62 receives predetermined control signals for actuating the valve 6 from the main processing unit, in particular set values of voltage and current and a predetermined parameterization of the adapter device, and processes these data. In addition, upon request, the sequencer 62 transmits information about the adapter device or the valve 6 to the main processing unit.

In addition to the parameterization by means of the external main computer unit not shown in the figures, the three rotary switches 44, 70, 72 in the form of coding switches are connected to the sequencer 62 (see FIG. 3) to parameterize the software S. A first rotary switch 44 is provided for setting an operating mode of the adapter device. If the adapter device is used for the first time in combination with an individual valve 6, the former has to be adapted to this valve 6 by means of a parameterization of the software parameters adapted to the individual valve 6. For this purpose, a second rotary switch 70 is provided for setting the nominal size of the individual valve 6. A third rotary switch 72 is provided for adjusting the switch-on and switch-off speed of the valve 6. The second 70 and the third 72 rotary switch each have sixteen switching positions.

Furthermore, a display means 56 in the form of a lamp, e.g. an LED, is connected to the sequencer 62 (see FIG. 3) to indicate a faulty operating status of the valve 6 or to indicate the switching position of the valve section 26 of the valve 6. The display means 56 is arranged on the outside of the adapter device and can be viewed by a user of the adapter device. However, the display means may also preferably be located on the circuit board.

The current detection device 50 (see FIG. 3) can have a shunt resistor, not shown in the figures, which can be connected to the coil 36 of the magnetic force actuator 32 via the connection device 14 in such a way that the current through the coil 36 also flows through the shunt resistor, across which the voltage drop is measured to determine the actual value of the control current i_{s,ist} of the coil 36. The current detection device 50 also has an amplifier 74 for amplifying the detected actual value of the control current i_{s,ist}, the amplification of which is adapted to an input-side analog/digital converter of the computing unit 46 for processing the amplified actual values of the control current I_{s,ist}. On the output side, the current detection device 50 transmits the amplified actual values of the control current I_{s,ist} to the resistance value computation module 58, to the induction voltage computation module 60, to the current regulator 66 and to the sequencer 62.

The voltage detection device 52 (see FIG. 3) determines and amplifies the actual values of the control voltage u_{s,ist} of the magnetic force actuator 32. Thus, the actual value of the control voltage u_{s,ist} of the coil 36 of the magnetic force actuator 32 is applied on the input side to the voltage detection device 52 via the connection device 14, which voltage detection device has a further amplifier 76 for amplifying the actual value of the control voltage u_{s,ist}, the amplification of which is adapted to another input-side analog/digital converter of the microcontroller for processing the amplified actual value of the control voltage U_{s,ist}. On the output side, the voltage determination device 52 transmits the measured and amplified actual values of the control voltage U_{s,ist} to the resistance value computation module 58, to the induction voltage computation module 60 and to the sequencer 62.

The resistance value computation module 58 (see FIG. 3) computes the value of the resistance R of the coil 36 of the magnetic force actuator 32 from the measured and amplified actual values of the control current I_{s,ist} and the measured and amplified actual values of the control voltage U_{s,ist}, and transmits this value to the induction voltage computation module 60.

The induction voltage computation module 60 (see FIG. 3) computes the actual values of the induced voltage u_{i,ist} of the coil 36 of the magnetic force actuator 32 from the measured and amplified actual values of the control current I_{s,ist}, the measured and amplified actual values of the control voltage U_{s,ist} and the computed value of the resistance R, and transmits these values to the voltage regulator 64.

The voltage regulator 64 (see FIG. 3) regulates the induced voltage u_{i,ist} of the coil 36 based on the actual values of the induced voltage u_{i,soll} and the target values of the induced voltage uᵢ transmitted by the sequencer 62 by issuing a signal from which the target value of the control current i_{s,soll} is derived.

The current regulator 66 (see FIG. 3) regulates the control current iₛ of the coil 36 based on the setpoint values of the control current i_{s,soll} and the actual values of the measured and amplified control current I_{s,ist}. Either the sequencer 62 or the voltage regulator 64 can be used to transmit the setpoint values of the control current i_{s,soll}. The switch 68 is provided for toggling between the outputs of these two software components.

For the sake of simplicity, the switch 68 is shown in FIG. 3 in the form of a hardware circuit and can be actuated by the sequencer 62 via a control line 78 in such a way that the input of the current regulator 66 is connected either to the sequencer 62 or to the output of the voltage regulator 64 for transmitting set values of the control current i_{s,soll}. In reality, however, the switch 68 is implemented exclusively in the software. If the switch 68 connects the sequencer 62 to the current regulator 66 and disconnects the voltage regulator 64 from the current regulator 66, the control current iₛ is regulated exclusively on the basis of the measured and amplified actual values of the control current I_{s,ist} and the specified setpoint values of the control current i_{s,soll}. If the switch 68 connects the output of the voltage regulator 64 to the current regulator 66 and separates the sequencer 62 from the current regulator 66, the regulation of the control current iₛ is based on a computed induction voltage of the coil 36, permitting the regulation to be performed more precisely.

The current regulator 66 generates a pulse width modulated signal PWM and transmits it to the output stage 48 (see FIG. 3) for amplification. The output stage 48 essentially has a half-bridge, not shown in the figures, in combination with a matching driver component, not shown in the figures. On the output side, the output stage 48 is connected to the coil 36 of the magnetic force actuator 32 of the valve 6 to deliver the control current iₛ via the connection device 14.

1. An adapter device for regulating a control current (iₛ) of a magnetic force actuator (32) of a valve (6), having a housing (8), into which the hardware (H) and the software (S) for regulating the control current (iₛ) of the magnetic force actuator (32) of the valve (6) are integrated, and which has a connection device (14) for detachably connecting to the valve (6) and a further connection device (18) for detachably connecting to a connector part (4), which can be used to supply the adapter device with current at least externally.

2. The adapter device according to claim 1, characterized in that the connection device (14) has means (16) for mechanically and electrically connecting the adapter device to the valve (6) in a detachable manner, in particular for connecting to the magnetic coil (36) of the magnetic force actuator (32) of the valve (6), and the further connection device (18) has means (20) for mechanically and electrically connecting the adapter device to the connector part (4) in a detachable manner.

3. The adapter device according to claim 1, characterized in that the hardware (H) comprises a computing unit (46) on which a method for regulating the control current (iₛ) of the software (S) is implemented.

4. The adapter device according to claim 1, characterized in that the hardware (H) comprises at least one rotary switch (44, 70, 72) for parameterizing the adapter device, which rotary switch is connected in a communicating manner to the computing unit (46), in particular to a sequencer (62) software-implemented on the computing unit (46).

5. The adapter device according to claim 1, characterized in that the hardware (H) comprises at least one display means (56), which can be switched by the computing unit (46) and is connected in particular to the sequencer (62), which is software-implemented on the computing unit (46).

6. The adapter device according to claim 1, characterized in that the hardware (H) has an output stage (48), which is connected to the computing unit (46), in particular to an output of a current regulator (66) software-implemented on the computing unit (46), on the input side and which can be connected to a coil (36) of the magnetic force actuator (32) on the output side.

7. The adapter device according to claim 1, characterized in that the hardware (H) comprises a current detection device (50) which can be connected to the coil (36) on the input side and which is connected to the computing unit (46) on the output side, in particular to a resistance value computing module (58) and/or to an induction voltage computing module (60) and/or to the current regulator (66) and/or to the sequencer (62), which are each software-implemented on the computing unit (46).

8. The adapter device according to claim 1, characterized in that the hardware (H) comprises a voltage detection device (52) by means of which the actual value of the control voltage (u_{s,ist}) can be tapped on the input side across the coil (36) of the magnetic force actuator (32) and which, on the output side, is connected to the computing unit (46), specifically to the resistance value computation module (58) and/or to the induction voltage computation module (60) and/or to the sequencer (62), which are each software-implemented on the computation unit (46).

9. The adapter device according to claim 1, characterized in that the current determining device (50) for amplifying the actual value of the control current (i_{s,ist}) and the voltage determining device (52) for amplifying the actual value of the control voltage (u_{s,ist}) each comprise an amplifier, the amplification of which is adapted in particular to a relevant input-side analog/digital converter of the microcontroller.

10. The adapter device according to claim 1, characterized in that the software (S) comprises a software-implemented resistance value computation module (58), which is connected to an output of the voltage determination device (52) on the input side and to an output of the current determination device (50) and which is connected to an input of a software-implemented induction voltage computation module (60) on the output side.

11. The adapter device according to claim 1, characterized in that the software (S) comprises the software-implemented induction voltage computation module (60), which is connected to an output of the resistance value computation module (58) on the input side, to the output of the voltage detection device (52) and to the output of the current detection device (50) and to a voltage regulator (64) on the output side.

12. The adapter device according to claim 1, characterized in that the software (S) comprises a software-implemented sequencer (62) for processing predetermined control signals for actuating the valve (6) and/or a predetermined parameterization of the adapter device, which can be connected to an external main computer unit for communication via the further connection device (18) and to which adapter device the at least one rotary switch (44, 70, 72) and/or the outputs of the current detection device (50) and/or the voltage detection device (52) are connected on the input side and which is connected to a voltage regulator (64) or a current regulator (66) on the output side, each of which is software-implemented.

13. The adapter device according to claim 1, characterized in that the software (S) includes the software-implemented voltage regulator (64), which is connected to the sequencer (62) for transmitting set values of the induced voltage (u_{i,soll}) and to the voltage computation module (60) for transmitting actual values of the induced voltage (u_{i,ist}) on the input side, and which is connected to an input of the current regulator (66) on the output side if required.

14. The adapter device according to claim 1, characterized in that the software (S) includes the software-implemented current regulator (66), one input of which is connected to the sequencer (62) or to the output of the voltage regulator (64) for transmitting set values of the control current (i_{s,soll}) and the other input of which is connected to the current detection device (50).

15. The adapter device according to claim 1, characterized in that the software (S) includes a software-implemented switch (68), which can be actuated by the sequencer (62) and which connects one input of the current regulator (66) to either the sequencer (62) or the output of the voltage regulator (64).

16. The adapter device according to claim 1, characterized in that the computing unit (46) feeds the output stage (48), and in particular the output of the current regulator (66) supplies a pulse-width-modulated signal to the input of the output stage (48).

17. The adapter device according to claim 1, characterized in that the software (S) in addition to the function of regulating the control current (iₛ) of the coil (36) of the magnetic force actuating device (32)
a function for reducing the current of the coil (36, in particular in continuous operation; and/or
a function for moving the valve part (26) at a predeterminable speed when switching on and off; and/or
a function for detecting the switching state of the valve (6); and/or
a function for monitoring valve parameters, such as the switching cycles, the lengths of the on/off intervals, the pick-up/drop-out current and/or the coil resistance.

18. A method for regulating a control current (iₛ) of a magnetic force actuator (32) of a valve (6), which has at least one coil (36), which can be used to operate the adapter device according to any one of the requirements above and the following steps:
a current detecting device (50) determines an actual value of the control current (i_{s,ist}) of the coil (36);
a current regulator (66) compares the determined actual value of the control current (i_{s,ist}) to a set-point value of the control current (i_{s,soll}); and
the current regulator (66) regulates the control current (iₛ) of the coil (36), based on the result of the comparison.

19. The method according to claim 18, characterized in that the set-point value of the control current (i_{s,soll}) is predetermined by a parameterization.

20. The method according to claim 18, characterized in that the set-point value of the control current (i_{s,soll}) is determined according to the following further steps:
a voltage-determining device (52) determines an actual value of the control voltage (u_{s,ist}) of the coil (36);
a resistance value computation module (58) determines a resistance value (R) of the coil (36) from the actual value of the control voltage (u_{s,ist}) and the actual value of the control current (i_{s,ist});
an induction voltage computation module (60) determines an actual value of the induced voltage (u_{i,ist}) of the coil (36) from the resistance value (R), from the actual value of the control voltage (u_{s,ist}) and from the actual value of the control current (i_{s,ist});
a voltage regulator (64) compares the determined actual value of the induced voltage (u_{i,ist} to a set-point value of the induced voltage (u_{i,soll}), which can be predetermined by parameterization; and
the voltage regulator (64) determines the setpoint value of the control current (i_{s,soll}), based on the result of the comparison.
